(19) United States
(12) Patent Application Publication
(10) Pub. No.: US 2002/0068125 A1
(43) Pub. Date: Jun. 6, 2002

(54) Composition comprising a fat phase, vegetable matter and salt

(75) Inventors: May Chu Tan, Valinhos (BR); Nicolaas Jan Verhoef, Vlaardingen (NL)

Correspondence Address: UNILEVER, PATENT DEPARTMENT, 45 RIVER ROAD, EDGEWATER, NJ, 07020, US

(73) Assignee: Lipton, Division of Conopco, Inc.

(21) Appl. No.: 09/964,006

(22) Filed: Sep. 26, 2001

(30) Foreign Application Priority Data
Sep. 26, 2000 (EP) 00308439.9

(51) Int. Cl. A23L 1/00

(52) U.S. Cl. 426/615

(57) ABSTRACT

Edible compositions containing a fat phase and vegetable matter from members of the botanical genus of Allium, such as onions, garlic, chives, leek or mixtures thereof. Said composition is suitable for food preparation processes, such as frying or simmering.

### FIELD OF THE INVENTION

The present invention relates to edible compositions containing a fat phase and vegetable matter from members of the botanical genus of Allium, such as onions, leek, garlic, shallots or mixtures thereof.

### BACKGROUND OF THE INVENTION

Vegetable matter from the botanical genus of Allium such as onions, shallots and garlic, are used in many different dishes to provide flavour, either fresh/raw or in (freshly) fried form. With respect to onions, frying diced or sliced onions form usually the start of the preparation of many dishes, e.g. by frying or simmering, prior to mixing in e.g. meat, other vegetables, stock, thickeners or mixtures thereof. This requires the need for cutting or chopping onions, which can be perceived as burdensome and a nasty task due to the aromas liberated. The same applies for other members of the botanical genus of Allium, such as for example garlic. Hence, there is a need for compositions consisting mainly of onions or other vegetable matter obtained from members of the botanical genus of Allium that are already cut in slices or chopped in dices. Preferably, those slices or dices should have an appearance close to being freshly cut or chopped (i.e. preferably not fully dried, pre-fried or frozen).

Furthermore, it is preferred that the product is ambient stable when closed.

In U.S. Pat. No. 4,572,836 edible sterilised herb compositions are disclosed, in which the herbs are presented in the form of a puree or paste of the (otherwise fresh) herbs in oil. Oil is present in 25-50%, herbs in amounts of 40-65%, and the compositions further contain salt, preservative and acid.

In WO 96/07334 herb compositions are disclosed which have been prepared a) in the absence of oxygen with salt(s) and/or water-activity controlling solutes or b) in the presence oxygen scavenging agents and/or salts. In either case the water activity of the mix is required to be less than 0.90.

WO 98/47386 describes pourable fat compositions containing 0-45% herbs and 5-60% thickener.

These documents provide solutions to stability problems that occur in typical herb compositions, particularly preservation of flavour and colour of the herbs. However, they do not provide a solution to problems encountered in compositions that contain high amounts of vegetable matter from members of the botanical genus of Allium.

Freshly cut or chopped onions (or other plants of the genus of Allium) contain considerable amounts of water; part of which is released when such chopped onions are stored, e.g. in oil or fat. This appears in particular when next to onions and oil also salt is present. The first few percent of water will remain not or hardly visible, but if more water is released a layer of water may separate, which is unattractive. This is the same to a variable degree for other vegetable matter (that may be used in stead of or next to the onions) such as garlic, shallots or leek.

### SUMMARY OF THE INVENTION

Hence, there is a need for a composition that provides a large amount of vegetable matter from members of the botanical genus of Allium, such as onions, garlic, leek, shallots or mixtures thereof in oil or fat, preferably in admixture with salt, which compositions show limited or no phase separation during several weeks or months upon storage.

It has now been found that the above may be achieved (at least in part) by an edible composition comprising (in percentage by weight):

| | |
|---|---|
| oil or fat | 10-60% |
| vegetable matter from members of the botanical genus of | 35-85% |
| Allium | |
| salt | 0.05-40% |
| water-binding agent | 0.05-4.5%. |

In the above compositions, the minor amount of water-binding agent will bind part or all of the water that may be liberated from the vegetable matter. Following this, water that may be liberated from the vegetable matter will to a large extent hardly or not visible to the consumer.

### DETAILED DESCRIPTION OF THE INVENTION

In the compositions according to the invention, the water liberated by the vegetable matter (e.g. onions), will be bound by the water-binding agent, and hence phase separation (resulting in a water layer) is less likely to occur. The water-binding agent is preferably a thickener. Most preferred thickeners are gums, starch, starch derivatives or mixtures thereof.

Vegetable matter is herein to be understood as to be vegetable matter from members of the botanical genus of Allium unless stated otherwise.

Preferred species of the botanical genus of Allium are onions, garlic, leek, shallots, chives, or mixtures thereof.

The invention is in particular suitable when the vegetable matter is present in a particulate form (i.e. particles exceeding a size of 1×1×1 mm), or solid particles such as slices, although part of the vegetable matter may be present as puree. Preferably, the amount of vegetable matter is 50-75% wt, based on the total composition. The vegetable matter is preferably fresh or in a form that resembles fresh vegetable matter, as opposite to fully dried or fully cooked vegetable matter. Nevertheless, it may be preferred to have some pre-treatment of the vegetable matter, which may include a blanching operation, or removing part of the water content. However, it is preferred that such vegetable matter still contains at least 50% (wt) of the water, based on its fresh form. The amount of fat or oil (taken together) is preferably 20-40% wt, based on the total composition.

The amount of salt to be used will depend on the intended use. If a small amount of the composition (e.g. one or a few spoonfulls) is used as part of a much larger dish, to boost flavour and aroma delivery, a high level of salt (0.05-40% wt based on total composition, although 1-30% may be preferred) can be included in the product according to the invention, as it is “diluted” to a proper concentration. This high level of salt enhances microbiological stability. However, for some markets the composition may be used as such (i.e. in its entirely: 300 g or more per 4 persons), depending on local habits and culture. In such cases, the level of salt should be less, as it is not so much “diluted” to tasteful levels. Thus, 1-10% may also be desired. For such compositions, as the level of salt is less, it may be desired to pasteurise the product, in order to obtain a satisfactory closed shelf life. The (total) amount of salt in the composition is preferably 1-20%, and more preferably 1-15% wt. Usually, the salt will be ordinary kitchen salt (i.e. NaCl), although other matter normally used in kitchen salt such as iodine and iodine compounds may be present as well. Also, part of the salt may be another salt than NaCl, such as KCl.

The amount of the water-binding agent is preferably 0.5-3% wt.

The composition according to the invention may further comprise one or more of: flavours, preservatives, colorants, acids. Regarding acids, in particular organic acids such as citric acid is preferred to reduce the pH, thereby increasing microbial stability. Preferably the pH is below 5, more preferably below 4.5.

The composition according to the invention may further comprise one or more of the following: herbs, spices and vegetable matter other than from member of the botanical genus of Allium.

For enhanced physical stability of the composition according to the invention, the oil or fat used may contain 0.1-20% (based on the total amount of oil or fat present) of fat solid at room temperature, preferably hardstock fat crystals such as RP70 or RPh70. More preferably this amount is 1-10%. The fat phase may further contain other components in small amounts, like lecithin 0.01-3% as anti-spatter agent.

As mentioned before, the composition according to the invention may be microbiologically stable as such due to the amount of salt, or it may contain further antimicrobial agents or have a reduced pH (e.g. by addition of acid). Also, the composition according to the invention may be pasteurised or sterilised, or be subjected to other preservation treatments.

### EXAMPLES

### Example 1

Fresh onions were diced to an approx. size of 5×5×7 mm, and mixed (for 3 minutes) with salt, citric acid and sodium bisulphite in the following amounts:

| | |
|---|---|
| Onions dices | 79.18 |
| Salt | 20 |
| Citric acid | 0.8 |
| Na Bisulphite | 0.02 |
| Total | 100.0% |

An oil mixture containing soy bean oil (BO) and 5% of hardened fat crystals (RPh7O) was prepared. All other minor ingredients were added to the oil phase. The onion fraction (also containing the garlic paste) was added to the oil phase, and mixing was continued for 10 minutes.

The final composition was:

| | |
|---|---|
| oil blend | 25% |
| onion pieces approx. | 57% |
| garlic paste | 2.6% |
| salt | 12% |
| citric acid | 0.4% |
| bisulfite | 0.008% |
| flavours | 2.4% |
| Ultrasperse M (starch, ex NSCC) | 0.6%. |

The oil blend contained 5% hardened fat (RPh70), the remainder was liquid oil (BO).

From the above composition, 84 samples were stored for 14 days at 30-35° C. None of the 84 samples showed visual phase separation.

As control, 84 samples were prepared along the above lines, but not containing Ultrasperse (or other starch). The result was that 65 out of 84 (77%) did show visual phase separation.

### Example 2

A mixture was obtained of fresh onions (diced to an approx. size of 10×10×6 mm) with the following other ingredients, except for the Ultrasperse M:

| | |
|---|---|
| Onions dices approx. | 89.7 |
| Salt | 8 |
| Citric acid | 0.9 |
| Na Bisuiphite | 0.02 |
| Potassium sorbate | 0.13 |
| EDTA | 0.01 |
| Ultrasperse N | 1.2 |
| Total | 100% |

By the following procedure:

Add ingredients see above (excl. starch: Ultrasperse M).

Mix every 15 minutes for a time period of 2 hours.

Add the starch Ultrasperse M and mix for 20 seconds.

After 15 min. heat the onions up to 75° C. in a warm water bath (90° C. ) under continuous stirring.

Pasteurize the onions for 3 minutes at 75° C.

Cool down the total product to 20° C. in a cold water bath (5° C.). Add a chilled fat blend (5° C.) and mix, so that the following final compositions are prepared:

### Example 2a

### Final Product approx. 70% (Onion)/30% (Fat)

| | Total | | Pasteurised |
|---|---|---|---|
| | Formula- | Fat | Onion |
| | tion | Phase | phase |
| Ingredients | % (w/w) | % (w/w) | % (w/w) |
| Herbex Fatblend (SF/5% | 28.94 | 28.94 | |
| RPh70) | | | |
| Bolec MT | 0.03 | 0.03 | |
| Fried Onion Flavour | 1.10 | 1.10 | |
| Onion cubes 10 × 10 × 6 mm | 62.82 | | 62.82 |
| Salt | 5.6 | | 5.6 |
| Citric Acid | 0.6 | | 0.6 |
| Bi-sulphite | 0.01 | | 0.01 |
| Potassium Sorbate | 0.09 | | 0.09 |
| Ultrasperse M | 0.8 | | 0.8 |
| EDTA | 0.01 | | 0.01 |
| Total | 100.0 | 30.07 | 69.93 |

### Example 2b

### Final Product approx. 80% (Onion)/20% (Fat)

| | Total | | Pasteurised |
|---|---|---|---|
| | Formula- | Fat | Onion |
| | tion | Phase | phase |
| Ingredients | % (w/w) | % (w/w) | % (w/w) |
| Herbex Fatblend (SF/5% | 18.73 | 18.73 | |
| RPh70) | | | |
| Bolec MT | 0.02 | 0.02 | |
| Fried Onion Flavour | 1.25 | 1.25 | |
| Onion cubes 10 × 10 × 6 mm | 71.79 | | 71.79 |
| Salt | 6.4 | | 6.4 |
| Citric Acid (fine) | 0.72 | | 0.72 |
| Bi-sulphite | 0.016 | | 0.016 |
| Potassium Sorbate (fine) | 0.1 | | 0.1 |
| Ultrasperse N | 0.96 | | 0.96 |
| EDTA | 0.01 | | 0.01 |
| Total | 100.0 | 20.0 | 80.0 |

### Example 2c

### Final Product approx. 80% (Onion)/20% (oil)

| | Total | | Pasteurised |
|---|---|---|---|
| | Formula- | Fat | Onion |
| | tion | Phase | phase |
| Ingredients | % (w/w) | % (w/w) | % (w/w) |
| Bean Oil | 18.73 | 13.73 | |
| Bolec MT | 0.02 | 0.02 | |
| Fried Onion Flavour | 1.25 | 1.25 | |
| Onion cubes 10 × 10 × 6 mm | 71.79 | | 71.79 |
| Salt | 6.4 | | 6.4 |
| Citric Acid | 0.72 | | 0.72 |
| Bi-sulphite | 0.016 | | 0.016 |
| Potassium Sorbate | 0.1 | | 0.1 |
| Ultrasperse N | 0.96 | | 0.96 |
| EDTA | 0.01 | | 0.01 |
| Total | 100.0 | 20.0 | 80.0 |

1. Edible composition comprising (in percentage by weight):

| | |
|---|---|
| oil or fat | 10-60% |
| vegetable matter from members of the botanical | 35-85% |
| genus of Allitna | |
| salt | 0.05-40% |
| water-binding agent | 0.05-4.5%. |

2. Composition according to claim 1, wherein the amount of salt is 1-30%

3. Composition according to claim 1, wherein the members of the genus of Allium comprise onions, garlic, leek, shallots, chives, or mixtures thereof.

4. Composition according to claims 1, wherein the water-binding agent comprises a thickener.

5. Composition according to claim 4, wherein the thickener comprises an edible gum, starch, starch-derivative or mixture thereof.

6. Composition according to claim 1 wherein the vegetable matter is present in sliced, particulate or puree form.

7. Composition according to claim 1, wherein the vegetable matter from members of the botanical genus of Allium contains at least 50% (wt) of the water, based on its fresh form.

8. Composition according to claim 1 wherein the amount of oil or fat is 20-40% wt.

9. Composition according to claim 1 wherein the amount of vegetable matter from members of the botanical genus of Allium is 50-75% wt.

10. Composition according to claim 1 wherein the amount of salt is 1-15% wt.

11. Composition according to claim 1 wherein the amount of water-binding agent is 0.5-3% wt

12. Composition according to claim 1 further comprising one or more of: flavours, preservatives, colourants.

13. Composition according to claim 1 further comprising, herbs, spices, and/or vegetable matter other than from members of the botanical genus of Allium.

14. Composition according to claim 1, having a pH of less than 4.5.

15. Composition according to claim 1, wherein the oil or fat contains 0.1-20% hardstock fat crystals, based on the tot al amount of oil or fat present.

16. Composition according to claim 1, further comprising 0.01-3% (wt) lecithin.
